(19) United States
(12) Patent Application Publication
(10) Pub. No.: US 2018/0116263 A1
(43) Pub. Date: May 3, 2018

(54) OMELET KIT

(71) Applicant: Sara T. Colburn, Longmeadow, MA (US)

(72) Inventor: Sara T. Colburn, Longmeadow, MA (US)

(21) Appl. No.: 15/337,719

(22) Filed: Oct. 28, 2016

(51) Int. Cl. A23L 15/00; B65D 25/04; B65D 85/72

(52) U.S. Cl. CPC A23L 15/00; A23V 2002/00; B65D 85/72; B65D 25/04

(57) ABSTRACT

A kit for preparing an egg-based meal includes a package having a first compartment and a second compartment. The first compartment is isolated from the second compartment. A pre-beaten egg ingredient is disposed within the first compartment and a non-egg ingredient is disposed within the second compartment. At least one sealing element is removably coupled to the package to seal the first compartment and the second compartment.

### BACKGROUND

The present disclosure relates to a kit containing all of the ingredients necessary for preparing a meal, and more particularly, a kit for preparing an omelet.

Omelets and other egg based breakfasts such as frittatas and scrambles traditionally require a variety of ingredients. In addition to eggs, these other ingredients may include cheese, vegetables, and meat to enhance the flavor of the dish. The amount of each non-egg ingredient included in an omelet is often substantially less than the smallest available quantity of each ingredient that must be purchased. As a result, the cost to prepare a single omelet is higher due to the need to purchase of all of the ingredients and the excess of each ingredient may result in food waste.

More convenient omelet preparations have been available in the form of frozen mixes, reconsitutable mixes containing powdered or dried eggs, and fully prepared frozen omelets. However, each of these forms suffers from degradation in flavor and/or texture due to the pre-mixing of the ingredients.

### SUMMARY

According to one embodiment, a kit for preparing an egg-based meal includes a package having a first compartment and a second compartment. The first compartment is isolated from the second compartment. A pre-beaten egg ingredient is disposed within the first compartment and a non-egg ingredient is disposed within the second compartment. At least one sealing element is removably coupled to the package to seal the first compartment and the second compartment.

In addition to one or more of the features described above, or as an alternative, further embodiments comprising an other non-egg ingredient, the other non-egg ingredient being disposed within the second compartment.

In addition to one or more of the features described above, or as an alternative, further embodiments the package further comprises a third compartment. The third compartment is isolated from the first compartment and the second compartment. The kit further comprises an other non-egg ingredient is disposed within the third compartment.

In addition to one or more of the features described above, or as an alternative, further embodiments the second compartment and the third compartment are substantially identical in at least one of size and shape.

In addition to one or more of the features described above, or as an alternative, further embodiments the first compartment and the second compartment are substantially identical in at least one of size and shape.

In addition to one or more of the features described above, or as an alternative, further embodiments the first compartment and the second compartment vary in at least one of size and shape.

In addition to one or more of the features described above, or as an alternative, further embodiments the first compartment is substantially larger than the second compartment.

In addition to one or more of the features described above, or as an alternative, further embodiments a size of the first compartment and the second compartment is selected based on an amount of corresponding ingredient stored therein.

In addition to one or more of the features described above, or as an alternative, further embodiments the first compartment and the second compartment are defined by a dividing wall positioned within an interior of a hollow chamber.

In addition to one or more of the features described above, or as an alternative, further embodiments the at least one sealing element includes a first sealing element removably coupled to the package at the first compartment and a second sealing element removably coupled to the package at the second compartment.

In addition to one or more of the features described above, or as an alternative, further embodiments the first sealing element and the second sealing element are integrally formed.

In addition to one or more of the features described above, or as an alternative, further embodiments the pre-beaten egg ingredient comprises at least one of egg yolk, egg white, or alternative egg products.

In addition to one or more of the features described above, or as an alternative, further embodiments the non-egg ingredient comprises at least one of meat, vegetable, fruit, and cheese.

According to another embodiment, a method for preparing an egg-based meal using a kit includes removing a sealing element from a first compartment of the kit, providing a pre-beaten egg ingredient disposed within the first compartment to a cooking device, removing the sealing element from a second compartment of the kit, and providing a non-egg ingredient disposed within the second compartment to the cooking device.

In addition to one or more of the features described above, or as an alternative, further embodiments providing the pre-beaten egg ingredient to the cooking device comprises providing only the pre-beaten egg ingredient to the cooking device.

In addition to one or more of the features described above, or as an alternative, further embodiments the sealing element comprises a first portion that seals the first compartment and a second portion that seals the second compartment.

In addition to one or more of the features described above, or as an alternative, further embodiments removing the sealing element from the first compartment comprises removing the first portion of the sealing element and removing the sealing element from the second compartment comprises removing the second portion of the sealing element.

In addition to one or more of the features described above, or as an alternative, further embodiments the pre-beaten egg ingredient is provided to the cooking device prior to the non-egg ingredient.

In addition to one or more of the features described above, or as an alternative, further embodiments comprising removing the sealing element from a third compartment and providing another non-egg ingredient stored within the third compartment to the cooking device.

In addition to one or more of the features described above, or as an alternative, further embodiments the sealing element is removed from the second compartment and the third compartment substantially simultaneously.

In addition to one or more of the features described above, or as an alternative, further embodiments the non-egg ingredient is provided to the cooking device prior to the another non-egg ingredient.

In addition to one or more of the features described above, or as an alternative, further embodiments the at least one non-egg ingredient is selected from a meat, vegetable, fruit, and cheese.

### BRIEF DESCRIPTION OF THE FIGURES

The accompanying drawings incorporated in and forming a part of the specification embodies several aspects of the present invention and, together with the description, serves to explain the principles of the invention. In the drawings:

FIG. 1 is a top view of a kit for preparing an omelet according to an embodiment;

FIG. 2 is a perspective view of the kit for preparing an omelet in FIG. 1 according to an embodiment;

FIG. 3 is a side view of the kit for preparing an omelet of FIGS. 1 and 2 according to an embodiment;

FIG. 4 is a top view or another kit for preparing an omelet according to an embodiment; and

FIG. 5 is a side view of the kit for preparing an omelet of FIG. 4 according to an embodiment.

The detailed description explains embodiments of the invention, together with advantages and features, by way of example with reference to the drawings.

### DETAILED DESCRIPTION

With reference now to the FIGS., a kit 20 for preparing an omelet or another egg-based meal is illustrated. Examples of other egg-based meals considered within the scope of the disclosure, include but are not limited to an egg scramble (a mixture of eggs and non-egg ingredients), a frittata, and a quiche for example. The kit 20 includes a package 22 having a plurality of distinct compartments 24 such that one or more ingredients for preparing the omelet are stored within each of the plurality of compartments 24. Although the kit 20 is illustrated in the FIGS. as including between two and four compartments 24, embodiments including any suitable number of compartments 24, such as between two compartments and ten compartments for example, are contemplated herein.

At least one of the plurality of compartments 24 is configured to store a pre-beaten or scrambled egg ingredient, separated from a shell and ready for immediate use. The pre-beaten egg ingredient may include egg yolk, egg white, or alternative egg products, such as Egg Beaters®, substitute egg yolk, substitute egg white, and/or any combination thereof. The pre-beaten egg ingredient may additionally include water, milk, or another liquid for example, such that the pre-beaten egg ingredient as contained within the compartment 24 may be supplied directly to a frying pan or baking dish for cooking without any additional or intermediary action. In an embodiment, the pre-beaten egg ingredient is contained within its own compartment 24, separate from the other non-egg ingredients of the kit 20.

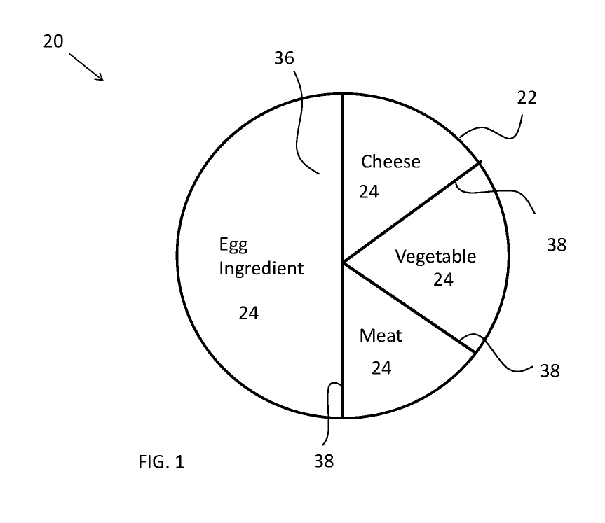

Each of the remaining compartments 24 is configured to store at least one non-egg ingredient to be included with the egg ingredient to prepare a desired meal. Each compartment 24 may be configured to contain an individual ingredient, separate from the other ingredients in the kit 20. However, embodiments where one or more of the compartments 24 includes a mixture of ingredients is also considered within the scope of the disclosure. Examples of non-egg ingredients that are commonly used in omelets or other egg-based meals and that may be stored within the plurality of compartments 24 of the package 22 include diced or cut tomato, onion, pepper, mushroom, bacon, ham, sausage, turkey, chicken, and cubes or shreds of cheese. The ingredients listed herein are intended as an example only, and any suitable food, herb, spice, sauce, condiment, or edible component may be arranged within one of the compartments 24. In addition, although the kit 20 as shown in FIG. 1 includes cheese, vegetable, and meat as the non-egg ingredients, any combination of non-egg ingredients is contemplated herein.

The plurality of compartments 24 may be substantially identical in size and/or shape, or alternatively, may vary. In one embodiment, the size of each compartment 24 is dependent on the quantity or volume of the one or more ingredients stored therein. As a result, the compartment 24 containing the pre-scrambled egg ingredient may be substantially larger than the other compartments 24. Further, the amounts of each non-egg ingredient may be substantially identical, or may vary based on the type of ingredient being included. In an embodiment, the quantity of each non-egg ingredient included in the kit 20 is dependent on the potency of the flavor of the ingredient.

The amount of each of the ingredients included in the kit 20 is selected such that the pre-scrambled egg ingredient and the additional non-egg ingredients, in combination, form a single serving meal, For example, the egg ingredient stored within a corresponding compartment 24 of the package 22 may be equivalent to two or three eggs and the quantity of each non-egg ingredient provided in the kit 20 may be similar to that used in a single-serving omelet. In an embodiment less than 1 cup, or ½ cup of each non-egg ingredient is included in the kit 20.

The kit 20 may be customized for the preparation of any of a plurality of egg-based products. As a result, the quantity of the pre-scrambled egg ingredient and the non-egg ingredients may vary based on such customization. For instance, the kit 20 may be customized for the preparation of a single-serving quiche. As a result of the increased egg content of a quiche relative to an omelet, the quantity of pre-scrambled egg ingredient provided within the kit 20 may be increased. Similarly, a quiche typically includes a reduced amount of non-egg ingredients compared to an omelet, so the quantity of the non-egg ingredients included in the kit 20 may be decreased.

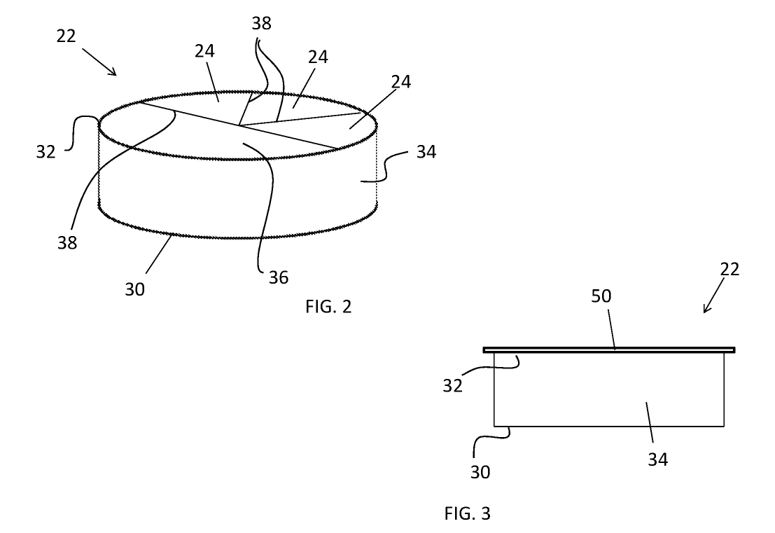

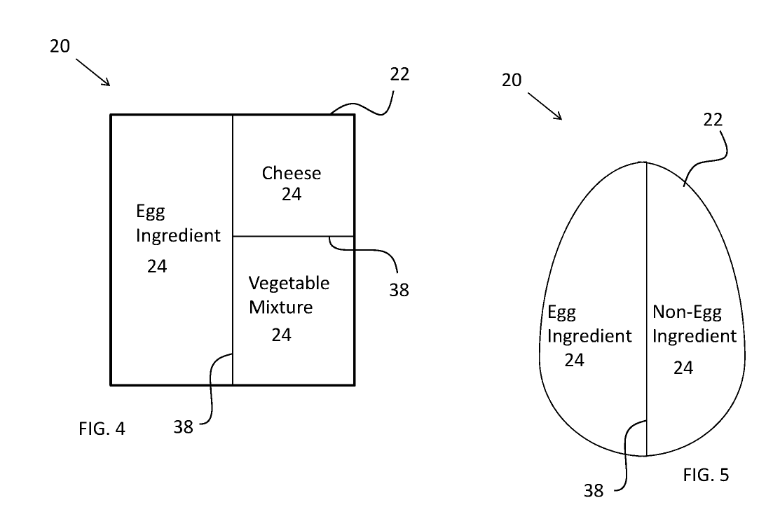

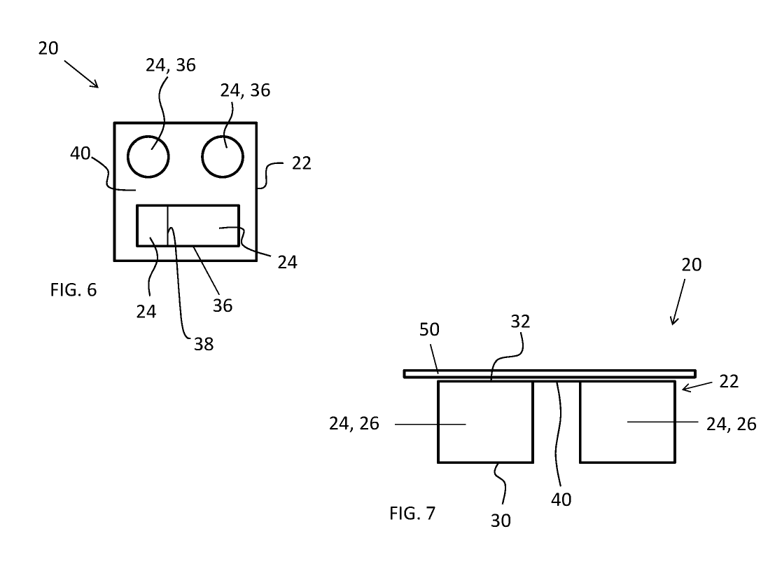

An example of the package 22 of kit 20 is illustrated in FIGS. 1-3. In the illustrated, non-limiting embodiment, the package 22 includes a closed first end 30, an open second end 32, and at least one sidewall 34 extending between the first end 30 and the second end 32 to define a hollow interior chamber 36 of the package 22. As shown, the package 22 is generally circular in shape; however it should be understood that a package 22 of any shape, such as rectangular (FIG. 4), square (FIG. 6), triangular, polygonal, or egg-shaped (FIG. 5) for example, is within the scope of the disclosure.

In the example of the kit 20 included in FIGS. 1-3, the generally hollow chamber 36 is subdivided into the plurality of compartments 24 via at least one dividing wall 38 integrally formed with the package 22. In another embodiment, shown in FIGS. 6 and 7, one or more of the plurality of compartments 24 may be spaced apart from the remainder of the plurality of compartments 24 by a distance. As shown, at least one compartment 24 is defined by a distinct hollow chamber 36 formed in a package 22. In such embodiments, a connecting member 40 may extend between and connect a portion of each of the plurality of chambers 36 to form the package 22.

With specific reference now to FIGS. 3 and 7, at least one removable sealing element 50 is positioned over the first open end 32 of the package 22 to cover one or more of the plurality of compartments 24 formed therein and to preserve the freshness of the ingredients included in the kit 20. The sealing element 50 may be formed from any suitable material, such as a foil or plastic for example, and in some embodiments may be at least partially transparent to allow a user to view the contents of the plurality of compartments 24. The sealing element 50 may be removably coupled to the open end 32 of the package 22 with any suitable means, such as a food safe adhesive, or a heat seal for example, such that the sealing element 50 may be easily removed by a user. In embodiments where the plurality of compartments 24 are integrally formed within a chamber 36, as shown in FIGS. 1-3, a single sealing element 50 may be used to seal the plurality of compartments 24. In such embodiments, the sealing element 50 may be removed from the plurality of compartments 24 as a single unitary piece. Alternatively, a perforation or seam may be formed in the sealing element 50 along one or more of the dividing walls 38. As a result, a user is able to remove portions of the sealing element 50 to selectively expose only a desired portion of the compartments 24. This allows a user to access and empty the pre-scrambled egg ingredient into a pan while retaining the non-egg ingredients sealed within their respective compartments 24. In embodiments where at least one of the plurality of compartments 24 is separated from the remainder of compartments 24 by a distance, as shown in FIG. 6, each chamber 36 defining one or more compartments 24 therein may include a separate sealing element 50.

To use the kit 20, a user simply removes the sealing element 50 associated with the compartment 24 containing the beaten egg ingredient to pour the beaten egg ingredient into a heated cooking device. The user may then remove the sealing element 50 from one or more compartments 24 containing non-egg ingredients, and provides those simultaneously, or sequentially to the cooking device containing the partially cooked beaten egg ingredient. Although the beaten-egg ingredient is described as being provided to the cooking device prior to the non-egg ingredients, embodiments where the beaten egg ingredient is provided to the cooking device after or at the same time as the non-egg ingredients are also contemplated herein.

The kit 20 illustrated and described herein conveniently provides a user with all of the necessary components to prepare an omelet or other egg-based meal. As a result, a user will no longer need to purchase a plurality of separate ingredients to prepare such a meal, resulting in a reduced cost and food waste.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A kit for preparing an egg-based meal, comprising:
a package having an integrally formed first compartment and a second compartment, the first compartment being isolated from the second compartment;
a pre-beaten egg ingredient disposed within the first compartment;
a non-egg ingredient disposed within the second compartment, wherein the pre-beaten egg ingredient and the non-egg ingredient are providable to a cooking device separate from the kit to prepare the egg-based meal; and
at least one sealing element removably coupled to the package to seal the first compartment and the second compartment.

2. The kit according to claim 1, further comprising another non-egg ingredient, the other non-egg ingredient being disposed within the second compartment.

3. The kit according to claim 1, wherein:
the package further comprises a third compartment, the third compartment being isolated from the first compartment and the second compartment; and
the kit further comprises another non-egg ingredient disposed within the third compartment.

4. The kit according to claim 3, wherein the second compartment and the third compartment are substantially identical in at least one of size and shape.

5. The kit according to claim 1, wherein the first compartment and the second compartment are substantially identical in at least one of size and shape.

6. The kit according to claim 1, wherein the first compartment and the second compartment vary in at least one of size and shape.

7. The kit according to claim 6, wherein the first compartment is substantially larger than the second compartment.

8. The kit according to claim 1, wherein a size of the first compartment and the second compartment is selected based on an amount of corresponding ingredient stored therein.

9. The kit according to claim 1, wherein the first compartment and the second compartment are defined by a dividing wall positioned within an interior of a hollow chamber.

10. The kit according to claim 1, wherein the at least one sealing element includes a first sealing element removably coupled to the package at the first compartment and a second sealing element removably coupled to the package at the second compartment.

11. The kit according to claim 10, wherein the first sealing element and the second sealing element are integrally formed.

12. The kit according to claim 1, wherein the pre-beaten egg ingredient comprises at least one of egg yolk, egg white, or alternative egg products.

13. The kit according to claim 1, wherein the non-egg ingredient comprises at least one of meat, vegetable, fruit, and cheese.

14. A method for preparing an egg-based meal using a kit, comprising:
removing a sealing element from a first compartment of the kit;
providing a pre-beaten egg ingredient disposed within the first compartment to a cooking device, the cooking device being separate from the kit;
removing the sealing element from a second compartment of the kit, the second compartment being integrally formed with the first compartment; and
providing a non-egg ingredient disposed within the second compartment to the cooking device.

15. The method according to claim 14, wherein providing the pre-beaten egg ingredient to the cooking device comprises providing only the pre-beaten egg ingredient to the cooking device.

16. The method according to claim 14, wherein the sealing element comprises a first portion that seals the first compartment and a second portion that seals the second compartment.

17. The method according to claim 16, wherein removing the sealing element from the first compartment comprises removing the first portion of the sealing element and removing the sealing element from the second compartment comprises removing the second portion of the sealing element.

18. The method according to claim 14, wherein the pre-beaten egg ingredient is provided to the cooking device prior to the non-egg ingredient.

19. The method according to claim 14, further comprising:
removing the sealing element from a third compartment; and
providing another non-egg ingredient stored within the third compartment to the cooking device.

20. The method according to claim 19, wherein the sealing element is removed from the second compartment and the third compartment substantially simultaneously.

21. The method according to claim 19, wherein the non-egg ingredient is provided to the cooking device prior to the another non-egg ingredient.

22. The method according to claim 14, wherein the at least one non-egg ingredient is selected from a meat, vegetable, fruit, and cheese.
